(19) United States
(12) Patent Application Publication
(10) Pub. No.: US 2023/0405958 A1
(43) Pub. Date: Dec. 21, 2023

(54) A SYSTEM AND A METHOD FOR ASSEMBLING A PACKAGING

(71) Applicant: Anheuser-Busch InBev S.A., Brussels (BE)

(72) Inventors: Wim Dekocker, Leuven (BE); David Rombaut, Hamme (BE); Ben Eylenbosch, Hamme (BE); Bjorn Vercauteren, Hamme (BE); Tim Cerpentier, Hamme (BE); Roderik Vancoster, Hamme (BE); Kristof Platteeuw, Hamme (BE); Keenan Thompson, Leuven (BE); Annalisa Narducci, Leuven (BE); Glenn Ferreira, Leuven (BE); Philippe Jean Marie Duperray, Châteauroux (FR); Manu Peelman, Hamme (BE); Tom Van Moer, Hamme (BE); Arne Vanheuverbeke, Hamme (BE); Frederik Triest, Hamme (BE)

(21) Appl. No.: 18/250,713

(22) PCT Filed: Oct. 28, 2021
(86) PCT No.: PCT/EP2021/080056

§ 371 Date: Apr. 26, 2023

(30) Foreign Application Priority Data
Oct. 29, 2020 (BE) BE2020/5773

(51) Int. Cl. B31B 50/00; B31B 50/26

(52) U.S. Cl. CPC B31B 50/006; B31B 50/262

(57) ABSTRACT

A system for processing a packaging in assembly comprising a main transportation unit (102); and a manipulator transportation unit (104) having at least one manipulating unit (110), said manipulating unit mounted on at least one independently motion controlled mover (108) and adapted for manipulating a material component of a package (106) in assembly present at the main transportation unit, wherein said manipulating unit comprises an engagement device (112) for temporarily engaging a material component of a package in assembly while being in transit.

### FIELD OF INVENTION

The present invention generally relates to assembling and packaging methods, equipment assemblies and systems. More particularly, the present invention relates to an assembling and packaging system, method and related machine with multiple transportation units equipped with multiple manipulation units for performing one or more packaging processes on packaging, such as secondary packaging, while in transit. In addition, the present invention also provides systems, methods, and machines for assembling and packaging of any other article.

### BACKGROUND OF INVENTION

For handling, assembling, folding, treating, and performing other such processing functions on packaging, such as secondary packages, many assembling methods and systems have been devised. Such assembling and packaging systems generally include one or more transportation units equipped with conventional means to move, handle and assemble the packaging. The conventional mechanisms are typically configured to move the packaging from one place to another, or from one machine to another, or from one driving track to another.

Transportation systems play an essential role in manufacturing industries for moving components and/or products from one place to another and/or through manufacturing processes. The driving tracks, roller and/or belt conveyors normally used, are usually driven by conventional AC or DC motors or servo drives and usually result in machine of fixed pitch.

In particular, many packaging assembly lines use linear motion driving tracks to move primary, secondary or tertiary packages in assembly, adopting one or more conventional means of executing manufacturing operations, while the packages are transported by the linear driving tracks.

These conventional manufacturing means usually employ such devices as guides, ploughs, cams, molds or rails of fixed or limited adjustment profile to progressively cause an action to occur as the packages are propelled through or along a manufacturing process. These methods typically require much in the way of linear length, invoke the need for change parts and are at best suitable for a limited range of products and formats.

Another conventional approach includes the use of indexing mechanisms along the main driving track, where the packages in assembly, move intermittently and remain stationary each time a packaging operation has to occur.

Yet other conventionally mechanized approach includes hand-off from the linear transportation systems to and from specific packaging machinery for execution of specific operations.

The above mentioned conventional methods are severely constrained in one or more features. Conventionally mechanized and automated methods are limited in terms of primary product and packaging type, style, size and format range and are of somewhat fixed execution at the time of purchase, requiring the acquisition of expensive and long lead, pack specific, change parts when new SKU's are introduced, and are still then severely limited in what is possible within the such machine architectures.

The need for product and pack specific change parts and the burden of having to swap out such change parts at machine changeover reduces productivity and limits product diversity.

In an attempt to provide a solution enabling packaging operations on the package in assembly while being in transit, WO2019007923A1 provides a partially flexible processing station for carrying out a work process on an article which is transported by a transport unit of a first conveying means. The invention provides for a process unit to be moved to the article with a transport unit of a second conveying means in the form of a long stator linear motor and for the transport unit to be moved with the first conveying means in the form of a long stator linear motor, wherein the movement of the transport unit of the second conveying means in the overlap region is synchronized, at least sometimes, with the movement of the transport unit of the first conveying means and, during the synchronization of the movements with the process unit, the work process is carried out on the article.

However, still these packaging systems have to change the packaging tools for packaging, depending on the type of product to be packaged; such as its shape, size, and weight and hence, these systems are package specific. This further reduces productivity.

Therefore, it is an objective of the present invention to enable freedom of package design and manufacturing flexibility at capacity via programmable dynamic manufacturing processes that cover exceptionally wide ranges of packages and product, type, size, shape and format, capable of handling and applying a range of packaging materials and components and being capable of executing optimized assembly sequences, while the package is in transit, in a highly flexible, programmable manner, all without the need for pack format or product specific change parts.

It is also an objective of the present invention to realize synchronized, highly flexible, large range, custom manufacturing operations at capacity, while in transit.

It is also an objective of the present invention to provide a recipe driven and/or dynamic packaging system that can implement one or more packaging components and packaging operations or manufacturing operations depending on the type of products to be packaged or operated upon.

It is further an objective of the present invention to provide an overall packaging machine which is compact, adaptive, coupled with digitalized solutions and eliminates the need for change in components or tools specific to products and/or to packages.

A further objective of the invention includes strong support of tooling adaptability and optimizable, software driven flexibility in the overall packaging machine.

It is also an objective of the present invention to achieve nimble flexibility at capacity for efficient assembly of an exceptionally wide range of products and package types, shapes, formats and assembly sequences via synchronized, adaptive manufacturing processes in pitch optimized, motion-controlled transit.

### SUMMARY OF THE INVENTION

In an aspect of the present invention, a system is provided for processing a packaging in assembly, said system comprising a manipulator transportation unit transporting at least one manipulating unit, said manipulating unit mounted on at least one independently motion controlled mover and adapted for manipulating a material component of a package in assembly present at a main transportation unit, characterized in that said manipulating unit comprises means for temporary attaching, and releasing, a material component of a package in assembly, while in transit. According to the disclosure is a system for processing a packaging in assembly comprising a main transportation unit; and a manipulator transportation unit having at least one manipulating unit, said manipulating unit mounted on at least one independently motion controlled mover and adapted for manipulating a material component of a package in assembly present at the main transportation unit, characterized in that said manipulating unit comprises an engagement device for temporarily engaging a material component of a package in assembly while being in transit.

The engagement device may be a means for temporary attaching, and releasing, a material component of a package.
The engagement device may be for temporarily attaching to and releasing from the material component of the package in assembly while being in transit.

In an embodiment, this present invention may utilize synchronized motion controlled packaging material manipulation by one or more independent motion controlled manipulating units alone or in synchronized combination with the motion relative to the package in assembly of the independent motion controlled mover upon which the manipulation unit is mounted or integrated with. (That is to say, the resultant action on the packaging material may be a synchronized combination of manipulator articulation along and/or around the x-, y-, z-axes relative to the mover and of the mover itself relative to the package in assembly being transported by the main transportation unit.

In an aspect of the present invention, the manipulation unit may bear on or temporarily attach, hold and/or manipulate and release a portion of a packaging material or an individual packaging material component and via 3-dimensional articulation or the tooling (end effectors) of the manipulation units, along and/or about the x-,y-,z-axes of the manipulation unit, relative to the mover upon which it is mounted, manipulate and/or form or shape and/or position the packaging material portion or component in the desired manner.

In an aspect of the present invention, said manipulation unit may be adapted to pick, fold, form, shape, wrap, bend, stretch, push, press, force, off-set, compress, tuck, pull, rotate, cut, crease, score, collapse, insert, align, latch or any combination thereof, the packaging material component.

The package in assembly may include secondary packaging (such as boxes, cartons, crates etc.) or tertiary packaging (such as pallets etc.). The packaging material component may include components of such secondary packaging (such as foldable packaging blanks, handle assemblies, partitions, reinforcement pieces, ribbons, etc), or components of such tertiary packaging (such as foils, etc).

Further, a system in accordance with the present invention may comprise a manipulation driving mechanism for driving said manipulation unit along and/or about the x-,y,-z axes of the manipulation mechanism relative to the mover upon which it is mounted, said manipulation driving mechanism comprising any type of actuation mechanism comprising any combination of and not being limited to direct drives (motors and/or actuators) and/or power transmission via, linkages, pivots, slides, gearing and/or rack & pinion transmissions, cable, pulley and/or cable & sheath arrangements, or lever and/or bell crank arrangements, being driven by motors or actuators directly or indirectly, on the manipulator unit or by varying the relative distances between two or more said independently motion controlled movers, connected by any actuation unit power transmission means.

In a particular aspect of the present invention, the manipulating unit comprises a base portion; a manipulator portion attached to the base portion and rotatable about the base portion; wherein the manipulation driving mechanism comprises a rotation driving mechanism for driving the rotation of the manipulator portion, and wherein the means for temporary attaching and releasing a material component of a package in assembly are located on the manipulator portion and/or the base portion. An engagement device may be for providing the temporary attaching and releasing.

In an aspect of the present invention, the manipulator portion of the manipulating unit is sufficiently rotatable to vary the position of the means for temporary attaching and releasing over an angle relative to the package in assembly.

In another aspect of the present invention, the manipulator portion of the manipulating unit is sufficiently translatable (i.e. a linear movement away from the base portion), alternatively or in addition to being rotatable, to vary the position of the means for temporary attaching and releasing in a linear direction relative to the package in assembly.

In an aspect of the present invention, the rotation driving mechanism of the manipulating unit comprises a linkage mechanism adapted for maintaining a force onto said material component.

In an aspect of the present invention, the mover mounted manipulator is suitable picking a packaging material component from a packaging material supply, forming, orienting, aligning, inserting, holding, pressing and releasing the additional packaging material component to the package in assembly, while in transit. These packaging components may include and are not limited to the supply and application of package handles, handle assemblies, ribbons, partitions, or reinforcement pieces to the main body of the package being assembled.

An aspect of the present invention provides the system, as described above, and which further includes the manipulator transportation unit, as described above, transports one or more pairs of the manipulating units manipulating the material component from opposed or from various directions.

In an aspect of the present invention, the manipulator transportation unit is a closed loop transportation unit.

In an aspect of the present invention, the manipulating units are wirelessly controlled and/or wireless powered (e.g. slip rail or inductively) and/or position sensed (e.g. magnetically or optically sensed).

In an aspect of the present invention, the services of inductive power and wireless control are used to power and control devices such as and not limited to linear and/or rotary actuators, pistons, pumps, compressors, vacuum pumps, solenoids, valves, switches, grippers, lamps, electro-magnets, ultra-sonic generators, vibration generators, heaters, electronic coolers, blowers, fans, lasers etc. and all manner of discrete and analog sensors and transmitters, thus enabling programmable control of the manipulator toolings and realizing status and condition feedback.

In an embodiment, the independently motion controlled movers of the manipulator transportation unit are mounted and moving on a rail or track (i.e. a linear motor or any other type of rail based or track based independent motion controlled mover system). Alternatively, the manipulator transportation unit is a magnetic driving surface and its independent motion controlled movers are levitating tiles. The levitating tiles may operate using magnetic levitation in a similar manner to a linear motor. Multiple stationary coils may be located in static tiles and mobile permanent magnets may be located in the movers. The coils and the permanent magnets are arranged in a horizontal plane. The coils in the tiles are electrically active and generate an electromagnetic field that causes the movers to levitate above the tiles.

The main transportation unit may also be a linear motor or any other type of rail based or track based independent motion controlled mover propelling system, or alternatively, it may comprise a magnetic driving surface and its independent motion controlled movers (i.e. package movers) are levitating tiles.

In a further embodiment in accordance with the present invention, both the main transportation unit and the one or more manipulator transportation units comprise a magnetic driving surface where the independent motion controlled movers are levitating tiles.

Another aspect of the present invention provides the system, as described above, and further comprising an assembly of at least two of the manipulator transportation units for manipulating from each side of the package in assembly on the main transportation unit (e.g. two pairs of package erecting units at each side of the main transportation unit.

In a further embodiment in accordance with the present invention, as described above, the arrangement of one or more manipulator transportation units about the package in assembly being transported by the pitch and pace setting main transportation unit, may be horizontally to the left, to the right, vertically above the main transportation unit (and hence the package in assembly) and also at any inclination there between (i.e. to the left or to the right at any inclination above and below the horizontal, up to vertically above and vertically below the route of the package in transit, which can be physically arranged to fit.

In a further embodiment in accordance with the present invention, as described above, with one or more manipulator transportation units, comprising one or more manipulator units, positioned about the main transportation unit track of the package in assembly and with the package in assembly being acted upon by toolings integrated into the pack transportation platform, along with the one or more manipulator units per manipulator transport unit supplying, applying and/or acting (forming the pack) opposite or across the package in assembly, while in transit, (i.e. supplying, applying, acting on the left and right rides, upper and lower corners, leading and trailing sides and/or edges, or otherwise about the package in transit) a manufacturing cell is established about the package in assembly while in transit.

In a further embodiment in accordance with the present invention, as described above, with the manipulator transportation units being position settable relative to the machine datum and the main transportation unit and the pitch of the independent movers being variable in machine direction, exceptional range in width, height and length of packs being assembled may be accommodated with the same toolings (end effectors) of the manipulator units. i.e. the size (volume) of the manufacturing cell may be scaled to the size of the package being assembled, enabling a wide range of application of the system for a given manipulator tooling execution.

A yet another aspect of the present invention provides the system, as described above and further comprising a control system enabling synchronization of the pace and pitch of the mover mounted manipulation units and actions of the manipulator unit toolings with the transportation of the package in assembly on the main transportation unit.

The main transportation unit may comprise individually motion controller movers and tools on the individually motion controlled movers; wherein the tools on the individually motion controller movers of the main transportation unit are configured to provide packaging process operations to said given packaging in assembly, and wherein the control unit enables the control of the manipulating units and said tools for simultaneously manipulating a material component of said given packaging in assembly. That is, the main transportation unit may also have individually motion controlled movers. These movers (of the main transportation unit) may have tools, and these tools may be configured to provide packaging process operations to a packaging in assembly.

In an aspect of the present invention, the main transportation unit comprises tools on individually motion controlled movers providing packaging process operations to a given packaging in assembly, and wherein the control unit enables the control of the manipulating units for simultaneously manipulating a material component of the given packaging in assembly together with the action of the main transportation unit tools.

In an aspect of the present invention, the system, as described above, comprises a plurality of the manipulator transportation units and wherein the control system further enables the control of the manipulating units for simultaneously picking, manipulating and applying packaging material components and/or the packaging material of the packages in assembly, while in transit.

Another aspect of the present invention provides the system as described above, and further comprising a change-over station for loading and/or receiving and storing inactive manipulation units and/or for adaptation and/or adjustment of manipulation units. The change-over station may be a designated area of the system where manipulation units may be located, out of the way of active manipulation units. For example, if the manipulator transportation unit includes a closed loop around which the manipulating units travel, the change-over station may be a parallel section, outside of the closed loop, where inactive manipulation units can be stored until they are to become active and transfer to the closed loop.

An aspect of the present invention provides an assembling method for assembling a package comprising the steps of providing a given package in assembly onto a main transportation unit, suppling (picking, forming, orientating and applying) packaging material components and manipulating a the main packaging material of the given package in assembly using a system of any of the above claims, while the packaging in assembly is in transit.

Another aspect of the present invention provides a method for assembling a package, employing the system as described above, where the manipulating comprises, i) moving one or more material components or part thereof into a given direction, ii) rotating the package in assembly or the final assembled package, iii) accelerating, decelerating, attaching, inserting, pressing, wrapping, holding, folding, tucking, off-setting, translating, rotating, pushing, pressing, inclining, stretching, compressing, collapsing, erecting, gluing, latching a material component of a package in assembly, and all combinations thereof.

In an embodiment, the material component to be manipulated is a part of a foldable blank based package.

It should be appreciated that all aspects and embodiments, systems, machines and methods described throughout the whole text in the context of processing, assembling and packaging a package may be equally applicable in the context of processing any other article, and in particular automotive parts, medical devices, toys, and consumer electronics.

### BRIEF DESCRIPTION OF DRAWINGS

FIG. 1 illustrates an assembling and packaging system, in accordance with an embodiment of the present invention;

FIG. 2 illustrates an embodiment of a manipulating unit of the manipulator transportation unit, in accordance with an embodiment of the present invention;

FIG. 3 illustrates the assembling and packaging system that includes the manipulator transportation unit with multiple manipulating units operating, from the top, on multiple packaging moving on the main transportation unit, at the bottom, in accordance with an embodiment of the present invention;

FIG. 4 illustrates the assembling and packaging system in accordance with an embodiment of the present invention;

FIG. 5 illustrates an example of manipulating unit, in accordance with an embodiment of the present invention.

FIG. 6 illustrates a configuration of the system, similar to as shown in FIG. 4, including multiple manipulating units operating on one secondary packaging, in accordance with an embodiment of the present invention;

FIG. 7 illustrates a folding and closing means of an exemplary manipulating unit, in accordance with an embodiment of the present invention;

FIG. 8 illustrates an example of manipulating unit, as shown in in FIG. 7, for closing a packaging in accordance with an embodiment of the present invention;

FIG. 9 illustrates a system including one manipulator transportation unit performing operations on one main transportation unit, in accordance with an embodiment of the present invention.

FIG. 10 illustrates another an example of manipulating unit, in accordance with an embodiment of the present invention.

### DETAILED DESCRIPTION

The present invention provides an assembling and a packaging system, and a related method for performing one or more assembling and packaging operations on packages in assembly. In an embodiment, the assembling and packaging system perform one or more assembling and packaging operations on a packaging in assembly while the packages are in transit. In an embodiment, the assembling and packaging system may perform one or more assembling and packaging operations on primary, secondary and/or tertiary types of packaging.

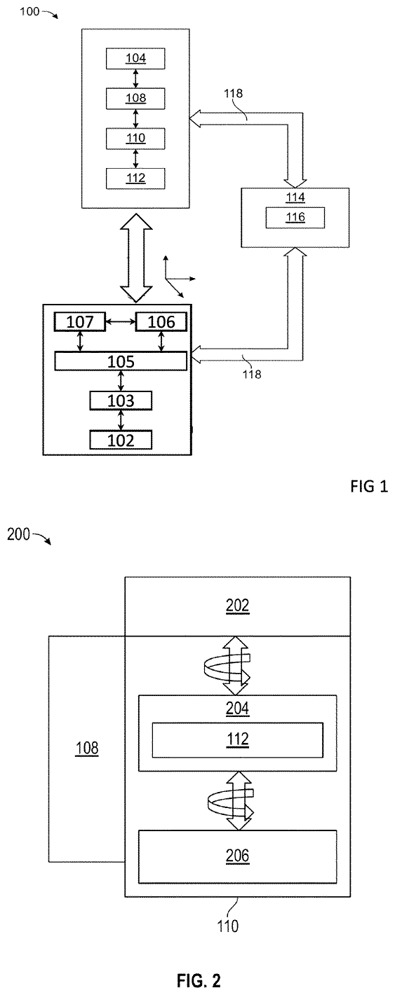

FIG. 1 illustrates an assembling and packaging system, in accordance with an embodiment of the present invention. In an aspect of the present invention as shown in the exemplary environment, the assembling and packaging system 100 comprises at least one main transportation unit 102 and at least one manipulator transportation unit 104.

The main transportation unit 102, comprises a plurality of movers or levitating tiles 103, used to transport each packaging 106 in assembly, through the manufacturing process in an independent, motion controlled, pitch and pace setting manner. The packages are supported, located and transported on optionally length adjustable packaging support decks 105, mounted from and optionally integrated with, one or more movers or levitating tiles 103. Pack manipulator units 107, may be optionally mounted on or integrated in the members which support the deck 105 off the movers or levitating tiles. The arrangement is such that combined with dynamic, synchronized support deck 105 length adjustment and action of the attached or embedded manipulator units 107, the main transportation unit not only transports the packaging in assembly through the manufacturing process, in an independent, motion controlled, pitch and pace setting manner, but also participates, along with manipulator units on any adjacent three dimensionally position settable transportation systems, in the assembly process. The packaging 106 may be a secondary packaging loaded or to be loaded with primary containers. In an embodiment, the packaging 106 may be a tertiary package loaded or to be loaded with secondary packaging.

The manipulator transportation unit 104 is equipped with a plurality of independent, motion controlled movers or levitating tiles 108, which are further mounted or integrated with one or more manipulating units 110. The manipulating units 110 are adapted for manipulating the main packaging material of secondary packaging and/or for picking, forming, orienting, aligning, inserting, holding, pressing and releasing an additional packaging material component to the secondary package 106 in assembly present at the main transportation unit 102. In an aspect of the present invention, the manipulating unit 110 comprises independent mover or levitating tile mounted, custom tooling comprising a base portion; a manipulator portion 112 attached to the base portion 202, either of which comprising potentially one or more manipulation driving mechanisms and a number of powered and controllable devices and feedback sensors, inductively or slip rail energized and bi-directionally, wirelessly controlled and wherein the means for temporary attaching and releasing a material component of a package in assembly are located on the manipulator and/or base portions. The means for temporary attaching and releasing a material component of a package may be an engagement device.

In the context of the present invention, temporary attaching may be obtained by a variety of different material handling/attaching devices such as and not limited to clamping grippers, suction grippers, Bernoulli suction heads, needle grippers, gecko (Van Der Waals Force) grippers, electro-static or magnetic adhesion, reuse adhesive grippers etc.

In an embodiment the present invention, the manipulator unit may (or may not) temporarily attach to the packaging material and via appropriate dexterity of the custom tooling, fold, wrap, bend, form, stretch, push, press, compress, tuck, off-set, pull, rotate, cut, align, insert, crease, latch or otherwise manipulate the targeted panel, flap or feature of the packaging material component and/or blank so being worked on.

In an embodiment of the present invention, the base portion of the custom tooling may be integrated into the body of the mover or levitating tile of the manipulator transportation unit.

In an aspect of the present invention, the one or more manipulation driving mechanisms may include direct coupling to motors or actuators and execute power transmission via all manner and combination of belt, sprocket, chain, shaft, cable, pulley, gear, rack & pinion, linkage, pivot, slide, conrod and/or bell crank arrangement etc.

The manipulation driving mechanism may be driven by on board motors or actuators or via mover—mover or tile—tile or tile—mover linkages, or any combination thereof, driven via variation in the relative distances between the said two or more movers and/or levitating tiles, i.e. via one or more (mover-mover), (tile-tile) or (tile-mover) mechanical linkage, rack & pinion, bell crank, inner/outer cable or cable & pulley arrangements, where in the actuation is realized via dynamic controlled variation of the individual pitches or two or more of the said movers and/or tiles from each other.

Further, the energized and controlled devices on the base and/or manipulator portions of the manipulating unit may include and are not limited to small linear and/or rotary actuators, motors, pumps, vacuum pumps, compressors, lamps, solenoids, valves, switches. grippers, electro-magnets, ultra-sonic generators, vibration generators, heaters, electronic coolers, blowers, fans, lasers etc.

In an embodiment, the energized and controlled sensors on the base and/or manipulator portions of the manipulating unit may include and are not limited to digital and analog sensors; switches (limit, pressure/vacuum, temperature, flow, force, position, velocity, acceleration/deceleration, vibration, illumination etc.); transmitters (position pressure/vacuum, level, temperature, force, flow rate, velocity, acceleration/deceleration, vibration level, illumination intensity, colour, etc.)

Each manipulating unit 110 has a means 112 for temporary attaching and releasing a material component of a package in assembly while being in transit. In the present example the means 112 for temporary attaching and releasing a material component of a package in assembly while being in transit is an engagement device. The means 112 may include and not be limited to gripping means, clamping means, suction means, folding means, a toothed folding means, a handling means or any combination thereof.

In the context of the present invention, in case the means for temporary attaching are suction means, the required relative vacuum may be generated for example by a vacuum pump and applied directly or via a vacuum chamber built into the body of the manipulator unit. Activation may be triggered for example by solenoid valves, and operational feedback may be given via vacuum switches or transmitters confirming successful attachment. In an embodiment, the mover 108 supports only manipulating unit 110, or supports several manipulating unit 110 optionally adapted differently for performing different operations dependent on the operations required.

In another embodiment, one manipulating unit 110 may be supported by several movers 108. For example, individual movement of movers 108 relative to each other and supporting one manipulating unit 110 may result in that manipulating unit 110 being moved, for example, articulated or retracted. Further, each manipulating unit 110 may have one or more packaging means 112.

The manipulating units 110 on the movers 108 of the manipulator transportation unit 104 perform the assembling and packaging operations, such as for instance folding and pressing a panel of a secondary package 106, such as a carton, in order to close the carton's panel. For this exemplary scenario, the manipulating units 110 may have one or more means 112, such as a suction means and a folding gripper means.

The suction means may hold the panel of the secondary package 106 firmly in place, and the folding gripper means may then fold the panel along an axis of folding and apply a small force over the folded panel to maintain the fold in the panel. It should be noted that this is just an exemplary scenario, and the manipulating units 110 may perform a variety of assembling and packaging operations on the secondary packages 106 in the assembly, while being in transit or not.

In an embodiment, each module of manipulator transportation unit 104 including the movers 108, manipulating unit 110 and the means 112 are position settable in three-dimensions operating opposite the main transportation unit 102.

All the independent motion-controlled movers 108 or the manipulator transportation unit 104, the independent motion controlled movers 103 of the main transportation unit 102, the actions of the toolings 107 of the mover mounted packaging in assembly support 105 on movers 103 and articulations of the manipulation portions 112 of the mover 108 mounted manipulation units 110 of the manipulation transportation units, are in precisely controlled synchronized motion, are powered in an untethered, motion unrestrained fashion via slip rail or contactless induction power supply and are communicated with by the control system via likewise untethered, motion unrestrained via two-way wireless telecommunication and contactless position sensed, to effect the desired wireless automation machine control.

The assembling and packaging operations include temporary attaching and releasing a material component or part of a secondary package 106, by the manipulating unit 110, in assembly and the assembling and packaging operations may further include and are not limited to holding, aligning, inserting, attaching, pressing, wrapping, folding, bending, forming, rotating, pushing, inclining, stretching, compressing, collapsing, erecting, latching, gluing a material component of a package in assembly, or moving one or more material components or part of it in a given direction or into a desired position, and all combinations thereof.

It may be apparent to a person ordinary skilled in the art that the system may require different well-known assembling and packaging operations to be performed on the packaging, and the system of the present invention is able to execute such well-known assembling and packaging operations via the assembling transportation unit equipped with manipulating units, without deviating from the meaning and scope of the present invention.

The present invention enables synchronized, motion-controlled manufacturing operations that, including consideration of integrated tooling within the package transportation carts, operate about the base, sides, corners, leading and trailing sides and edges and the top of the packages in assembly, while in transit.

Further, the present invention contributes to a modular and programmable execution of the packaging machine with wide dimensional adjustment range (position, height and width of linear drives), and capability for package family tooling, and flexibility in operational sequences that further gives rise to profound freedoms of packaging design.

In an embodiment, the material component of to be manipulated is a part of a foldable blank based package.

The manipulator transportation unit 104 is positioned relative to the main transportation unit 102 so that the manipulating units 110 are able to perform one or more assembling and packaging operations on the secondary packages 106.

The main transportation unit 102 and the manipulator transportation unit 104 are able to move with respect to each other in one or more dimensions. Both the units may include a movement system, as for example rails or tracks or slides or linear motors or robotics, or overhead frames or overhead robots, stand-alone or integrated with the main transportation unit, or integrated in a system frame or machine frame.

Further, in an embodiment, the main transportation unit 102 may also have one or more independently motion controlled package movers over which the secondary packages 106 can be mounted and transported relative to the manipulator transportation unit 104. In another embodiment, the main transportation unit 102 may also have one or more handling units mounted on one or more independently motion controlled package movers. Where the handling units can handle, orient and transport the secondary packages 106. In such embodiments, the handling means may also orient the secondary packages 106 in multiple orientations, angles and positions relative to the main transportation unit 102 and the manipulator transportation unit 104, such that the manipulating units 110 of the manipulator transportation unit 104 can perform the assembling and packaging operations on the secondary packages 106 from any and/or all sides and dimensions and in multiple degrees of freedom.

The secondary package 106 may include and is not limited to cartons, boxes, crates, and the like into which a primary container, such as including and is not limited bottles, cans, kegs, glassware, promotional items and marketing information can be packed.

In operation, the main transportation unit 102 transports the packaging 106 through the assembly process with toolings 107 integrated into the packaging support 105 taking part in the manufacturing process while the package in assembly is in transit. The manipulator transportation unit 104 is position adjustable relative to the main transportation unit 102. The manipulator transportation unit 104 transports the movers 108, may be referred to as manipulating movers 108, upon one or more of which each manipulating unit 110 is mounted. Each mover 108 mounted manipulating unit 110 comprising a base portion and a manipulating portion 112. The manipulating units 110 with the packaging means 112 perform one or more required operations on the individual packaging 106 at the main transportation unit 102 in the assembly. Further, in an embodiment, each manipulating unit 110 has the manipulation means 112 which can operate or handle or assemble elements of the secondary package 106 in 3-dimensions. Also, to work from every side and dimension of the secondary package 106, the manipulator transportation unit 104 also transports one or more pairs of the manipulating units 110 manipulating the material component from opposed directions. Thus, in an embodiment, the system 100 may also have two opposing manipulator transportation units 104, each with opposing pairs of the manipulating units 110 working on the secondary package 106 from its opposing sides (eg. On the left or right hand leading and trailing corners or leading and trailing sides of the pack), and where the secondary package 106 is transported in between two or more opposing manipulator transportation units 104 with opposing pairs of the manipulating units 110 acting simultaneously on the left, right and/or top sides and/or leading and trailing sides and/or edges.

In an embodiment, the two opposing manipulator transportation units 104 may be parallel or non-parallel to each other depending on the requirement and design of the assembling and packaging operations be performed in the system 100, without deviating from the meaning and scope of the present invention.

In an exemplary scenario, one opposing pair of the manipulating units 110 perform the assembling and packaging operations on the secondary package 106 being transported in between. In another exemplary scenario, two opposing pairs of the manipulating units 110 perform the assembling and packaging operations on the secondary package 110 being transported in between. In an example, two pairs of erecting devices as manipulating devices 110 are positioned at each side of pack 106 on the main transportation unit 102, acting on, forming and closing each side and corner of the package in assembly.

Further, the secondary package 106 can be transported in different orientations, angles, rotations, positions, and in multiple degrees of freedom, relative to both the main transportation unit 102 and the manipulating units 110 of the manipulator transportation unit 104. For example, the secondary package 106 can be transported in an upright position on the main transportation unit 102, or upside down position on the main transportation unit 102 or hung upside down position from the main transportation unit 102 which may be at top relative to the manipulator transportation unit 104. In a further example, completed assembled packs may be discharged from the main transportation unit via an overhead transfer unit with independent mover mounted tools acting on the top of the closed cartons or engaging with the handles of assembled carton totes or baskets (Eg. Transfer of packs from the main transportation unit by overhead transfer unit gasping the packs via suction pads attaching to the top surfaces of the packs or by manipulator mechanisms engaging in the handles of the packs or baskets).

Further, in an embodiment, the system may have one or more manipulator transportation units 104 enveloping the main transportation unit 102 from all sides, such as top, bottom and two sides, at once or in different required combinations to perform the operations on the secondary packages 106 on the main transportation unit 102 in between those manipulator transportation units 104.

In another embodiment, the system may have one or more main transportation unit 102 enveloping the manipulator transportation unit 104 from all sides, such as top, bottom and two sides, at once or in different required combinations so that manipulating units 110 on this one in between the manipulator transportation unit 104 perform the operations on multiple secondary packages 106 on the multiple main transportation units 102 surrounding the manipulator transportation unit 104.

Furthermore, the movers 108 and the mounted manipulating units 110 are automatically controlled, with the manipulation units typically being customized, lightweight, strong, adjustable, powered and controlled and dynamically programmable toolings.

In an embodiment, the main transportation unit 102 transports or transfers the secondary packages 106 to the manipulating units 110 mounted on the manipulator transportation unit 104. In another embodiment, the manipulator transportation unit 104 transports or transfers the manipulating units 110 to the secondary packages 106, on the main transportation unit 102, for performing the operations on the secondary packages 106. In another embodiment, both the main transportation unit 102 and the manipulator transportation unit 104 move relative each other while the manipulating units 110 perform the one or more operations at the secondary packages 106 in the assembly, and also while secondary packages 106 are in transit.

In an aspect of the invention, the manipulator transportation unit 104 is 3-dimensionally moveable relative to the main transportation unit 102. In an embodiment, the manipulator transportation unit 104 is able to translate and/or rotate (often referred to as pitch, yaw, and roll) around one or more of the X, Y, Z axes and all combinations thereof.

In an embodiment, the manipulator transportation unit 104 is able to move along and/or around a vertical axis (Z), e.g. variability in height and/or angular alignment relative to the main transportation unit 102, along and/or around a horizontal axis (X), e.g. variability in position and/or angular alignment in a direction parallel to the main transportation unit 102 machine direction, and along and/or about a second horizontal axis (Y), e.g. variability in position and/or angular alignment in a direction perpendicular to the main transportation unit 102 machine direction.

In an embodiment, the manipulator transportation units 104 are placed at various angles or positions with respect to the main transportation unit 102 and are position settable with six degrees of freedom such that the manipulator transportation units 104 are able to perform the operations, in three dimensions and in multiple degrees of freedom, at the packages 106 onto the main transportation unit 102. Therefore, the system 100 is able to achieve maximum degree of flexibility and dynamic in providing the packaging operations to the packages onto the main transportation unit 102.

In an embodiment of the present invention, the system 100 may include at least three manipulator transportation units 104 enveloping the main transportation unit 102 from at least three sides, inclined to the main transportation unit 102 at any suitable angle (including 00), situated at any suitable distance from main transportation unit 102 and moving independently in three dimensions with respect to the main transportation unit 102, thereby covering movement about the main transportation unit 102 in maximum degrees of freedom, giving the system 100 enormous flexibility in performing operations on the packages 106 on the main transportation unit 102, without deviating from the meaning and scope of the present invention.

In a further embodiment, the system 100 may include a plurality of main transportation units 102 enveloping the manipulator transportation unit 104 from at least three sides, inclined to the manipulator transportation unit 104 at any suitable angle (including 00), situated at any suitable distance from manipulator transportation unit 104 and moving independently in three dimensions with respect to the manipulator transportation unit 104, thereby covering the manipulator transportation unit 104 from all sides. In such scenario, the main transportation unit 102 can transport packaging 106 to the manipulating units 110 on the manipulator transportation unit 104 from any side, in any orientation, as required, for example even in upside down orientation, or packaging tilted at a certain angle being transported in X dimension related to the manipulator transportation unit 104. Thus, such aspects of the give the system 100 enormous flexibility in performing operations on the packages on the main transportation unit 102, without deviating from the meaning and scope of the present invention.

In an embodiment, at least one or all of the components of the system 100, including the main transportation unit 102 propelling independent movers 103 and the mover 103 mounted toolings 107 and/or the manipulator transportation unit 104 propelling independent movers 108 and the mover 108 mounted manipulating units 110 with the manipulation means 112 are controlled by a central control system 114 of the controlling unit 114. The controlling unit 114 may be a local or a remote controlling device for controlling the operations of the system 100, and may be an industrial controller, PLC and/or IPC, wherein the HMI interface can be accessed via any type of user interface devices (eg. Smart Phone, Tablet, Phablet etc.). The controlling unit 114 may be wired and/or wirelessly connected to control the overall system 100 implementing a wired communication protocol and/or a wireless communication protocol as required. A wired communication protocol may include and is not limited to cable connections, optical fiber cables, Ethernet, LAN, and the like. A wireless communication protocol may include and is not limited to two-way short range wireless, such as Bluetooth, Infrared, narrow through broadband telecommunication or WLAN, WAN, or Internet protocols and the like.

In an embodiment for wireless operation control of the components of the system 100, the components may be equipped with an antenna for wireless communication via wireless communication links such as narrow through broadband, low latency, deterministic, telecommunication, WLAN or WAN etc. In such embodiments, the manipulator transportation unit 104 propelling the mover 108 and/or the manipulating units 110 with the integrated packaging means 112 may form a dedicated wireless network within which the manipulating units 110 may be wirelessly controlled via a data transmission cable following the closed loop or virtual closed loop of each track/mover route. Further, in an embodiment, the manipulating units 110 may be independently wirelessly controlled within their own dedicated wireless network. Also, the movers of the main transportation unit and/or the manipulator transportation unit may be wirelessly controlled depending on the type of transportation unit used.

The components of the system 100 communicate bi-directionally with the controlling unit 114 via the communication channel 118, for example a communication fieldbus 118. The controlling unit 114 is installed with a software application 116 that monitors, controls and optimizes operations of the overall system 100, including the main transportation unit 102, the manipulator transportation unit 104 and their modules, such as the secondary package 106, the movers 108, the manipulating units 110 and the packaging means 112.

The software application 116 may analyze the positioning measurements of the modules of the main transportation unit 102 and the manipulator transportation unit 104 and provide optimized paths, or positioning, or track management functions for the overall system 100 to the controlling unit 114, to further monitor and control the position and movements of components of the system 100. The controlling unit 114 also enables synchronization of the pace and pitch of the manipulating units 110 with the pace and pitch of the transportation of the secondary packaging 106 on the main transportation unit 102. The controlling unit 114 system further enables controlling the relative movement of the manipulating units 110 relative to the secondary packages 106.

The synchronization may include local translation of the mover or levitating tile relative to the package in assembly, with the action of the manipulator unit, that one or more actuate and simultaneously translate actions occur of the tooling to effect the desired motion geometry and hence resulting action on the packaging material or complete pack, while the packaging in assembly is in transit.

Further, the synchronization may include local 3-dimensional translation and/or rotation of the mover or levitating tile relative to the package in assembly process with the action of the manipulator unit that one or more actuate and simultaneously translate actions occur in combination with all or part of the action being driven by variation in the relative distances between one or more mover-mover, tile-tile or tile-mover linkages, or any combination thereof, while the packaging in assembly is in transit.

Further, the software application 116, in communication with one or more sensors, may also detect a current position and arrangement of the packaging means 112, and may signal the manipulating units 110 to adapt or change the current position and arrangement of the packaging means 112 according to the size, shape and design of the secondary package 106.

In an embodiment, the controlling unit 114 controls the movement of the manipulator transportation unit 104, the manipulating units 110 and the packaging means 112 relative to the secondary packages 106. Additionally, the controlling unit 114 may also control movement of secondary packages 106 on the main transportation unit 102, or relative to a primary container manipulator transportation unit or the manipulating units.

In an embodiment, the manipulator transportation unit 104 comprises one or more tools on individually motion controlled movers 108 providing packaging process operations to a given packaging 106 in assembly, and the controlling unit 114 further enables the control of the manipulating units 110 for simultaneously manipulating a material component of the given packaging 106 in assembly.

In an embodiment, the controlling unit 114 further enables the control of the 3-dimensional movement of the manipulating units 110, the manipulator transportation units 104 for simultaneously providing one or more material components to a given secondary package 106 in assembly and/or simultaneously providing packaging operations to the given packaging 106 in assembly.

The system 100 may also include at least one of the main transportation unit 102 and at least one of the manipulator transportation unit 104 being a closed loop, including a virtual closed loop.

Further, the system 100 may also include a change-over station for receiving, adjusting, storing, swapping, inspecting, testing, adapting and inserting tools from/to movers and/or entire movers complete with mover mounted tools and/or fixtures.

In an embodiment, the system 100 as described is able to transport the individual secondary packages 106, either being levitated on package movers or driven on linear open, closed or virtual closed loop tracks, to and through the plurality of manipulator transportation units 104, where the manipulator transportation units 104 may further include one or more machines performing packaging operations on the secondary packages 106.

Thus, the system 100 comprises multiple manipulating units 110 with packaging means 112 which are programmable robotic custom tools and are mounted on movers 108 of manipulator transportation unit 104. The manipulator transportation unit 104 may be position adjustable linear drives. The main transportation unit 102 may also be position adjustable linear drives. The manipulator transportation unit 104 may be configured and optimally controlled to operate on the packages 106 while following the motion profile of the main transportation unit 102 and hence travelling with the package 106 being operated on at the main transportation unit 102.

In an embodiment, the system 100 is a machine that comprises plurality of systems 100 and the main transportation unit 102 is a continuous transportation unit through the plurality of systems 100.

In an embodiment, all the software-controlled components in the system 100 may be re-programmed and exchanged or upgraded to suit a broad range (family) of secondary packages 106 being operated on, thus ensuring the system 100 remains relevant and suitable for optimized performance.

In another embodiment of the present invention, the main transportation unit 102 may also drive one or more independently motion controlled package movers magnetically, where each package mover is magnetically coupled with the main transportation unit 102 in a contactless manner. In this embodiment, the main transportation unit 102 is also inductively controlled and may have electrical coils, while the package mover may be equipped with a permanent magnet for creating an electromagnetic field between the main transportation unit 102 and the package mover. Therefore, the package mover moves freely, in a flying motion over the main transportation unit 102 under the effect of electromagnetic forces generated due to the electromagnetic coil in the main transportation unit 102 and the permanent magnet in the package mover. The package mover acts as levitating tiles to hold the secondary packages 106 for transporting.

In an embodiment, the manipulator transportation unit 104 may be implemented with inductive cables from which inductive power is transmitted via the movers 108 to the manipulating units 110.

FIG. 2 illustrates an embodiment of the manipulating unit 110 of the manipulator transportation unit 104, in accordance with an embodiment of the present invention. The embodiment 200 of the manipulating unit 110 shows the manipulating unit 110 including a base portion 202; a manipulator portion 204 attached to the base portion 202 and rotatable about the base portion 202; a rotation driving mechanism 206 for driving the rotation of the manipulator portion 204; and the means 112 for temporary attaching and releasing a material component of a package 106 in assembly are located on the manipulator portion 204.

The manipulating unit 110 is mounted on the mover 108, which is further mounted in the manipulator transportation unit 104. In an embodiment, the manipulating unit 110 may further include an inductive power pick-up unit via which the manipulating unit 110 may receive power from an inductive power supply cable following the track/path of the mover upon which the manipulation unit 110 is mounted.

In an embodiment, the manipulating unit 110 may further include a wireless device (wireless client) which enables wireless machine control telecommunication of the manipulating unit 110 and its components with the control system via a master transmitter receiver device communicating wirelessly with one or more wireless clients (transmitter receiver devices).

In a further embodiment, the manipulating unit 110 may further include a wireless device (client transmitter receiver) with an antenna mounted close to and directly opposite a radiating cable antenna of the wireless master, following the track/path of the mover upon which the manipulation 110 unit is mounted.

The manipulator portion 204 is sufficiently rotatable to vary the position of the temporary packaging material attachment/engagement means 112 over an angle relative to the package 106 in assembly. The manipulator portion 204 may have one or more means 112 for performing a variety of packaging operations on one single packaging 106. In an embodiment, the whole manipulator portion 204 along with the means 112 attached to it is rotatable in a wide range of angles and orientations of position, and is able to incline, or to tilt, or to rotate around one or more of the X, Y, Z axes and all combinations thereof with respect to the base portion 202, and also the mover 108. In another embodiment, the manipulator portion 204 is fixed while the means 112 attached to it is rotatable and is able to incline, or to tilt, or to rotate around one or more of the X, Y, Z axes and all combinations thereof in a wide range of angles and orientations of position with respect to manipulator portion 204.

In another embodiment, the manipulator portion 204 can be moved along a vertical axis (Z) relative to the base portion 202 and also the mover 108, along a horizontal axis (X) in machine direction relative to the base portion 202 and also the mover 108, and along a second horizontal axis (Y) perpendicular to machine direction relative to the base portion 202 and also the mover 108. Thus, the manipulator portion 204 can be moved closer and away from the base portion 202 and the mover 108, or in any angle with respect to base portion 202 and the mover 108.

In another embodiment, the whole manipulating unit 110 is able to move and rotate in motions with respect to the mover 108, as explained above.

Further, the manipulator portion's 204 ability to move and rotate with respect to the base portion 202 and the mover 108 owes to a driving mechanism. The driving mechanism includes a drive mechanism between the manipulator portion 204 and the base portion 202, and further in the base portion 202 and the mover 108. This drive mechanism may comprise any type of actuation mechanism comprising any combination of and not being limited to direct drives (motors and/or actuators) and/or power transmission via, linkages, pivots, slides, gearing and/or rack & pinion transmissions, cable, pulley and/or cable & sheath arrangements, or lever and/or bell crank arrangements, being driven by motors or actuators directly or indirectly, on the manipulator unit or by varying the relative distances between two or more said independently motion controlled movers, connected by any actuation unit power transmission means.

Additionally, a driving mechanism also exists for driving the means 112 of the manipulator portion 204. The forces in movements of the manipulator portion 204 are traversed to the driving mechanism of the means 112 to eventually drive the means 112. This driving mechanism of the means 112 comprises a mechanism that is adapted for maintaining a force onto a material component of the secondary package 106, when the means 112 is performing a packaging and assembling operation on a component or part of the secondary package 106. This drive mechanism may comprise any type of actuation mechanism comprising any combination of and not being limited to direct drives (motors and/or actuators) and/or power transmission via, linkages, pivots, slides, gearing and/or rack & pinion transmissions, cable, pulley and/or cable & sheath arrangements, or lever and/or bell crank arrangements, being driven by motors or actuators directly or indirectly, on the manipulator unit or by varying the relative distances between two or more said independently motion controlled movers, connected by any actuation unit power transmission means.

Thus, the means 112 are attached to the manipulator portion 204 via this drive mechanism, and are rotatable, or moved in multiple dimensions and multiple degrees of freedom with respect to the manipulator portion 204.

In an embodiment, the driving mechanisms, for the means 112 are attached to the manipulator portion 204 and for the manipulator portion 204 itself, are actuated by an actuation device included in the manipulating unit 110, such as an actuation motor. This actuation device may receive power from the manipulator transportation unit 104 via an inductive power supply cable following the track/path of the mover upon which the manipulation unit 110 is mounted.

For example, the means 112 may include a folding means with suction cups that grips (temporarily) and folds a panel of a packaging 106. The folding means with suction cups is connected to the manipulator portion 204 (or the base portion 202 of the manipulating unit 110) via a series hinged and rotatable linking rods, arms, paddles or members. These hinged and rotatable linking rods, arms, paddles or members provide the driving and linking mechanism to the folding means 112. Thus, the folding means with suction cups can be rotated and moved in any required direction, in any required orientation, and in any required dimension.

To fold a panel of a packaging 106, the suction cups in the folding means may grip and hold the panel, while the folding means can rotate and fold the panel, owing to its rotation because of the series hinged and rotatable linking rods, arms, paddles or members. The folding means can fold the panel along a line of fold. Also, a small force can be applied by the folding means with suction cups on the folded panel, using the linkage mechanism of series hinged and rotatable linking rods, arms, paddles or members, to keep the fold in place.

Further in the folding action or to perform any other assembling and packaging operation on the packaging 106, the manipulator portion 204 with the means 112 of the manipulating unit 110 temporarily attaches and releases a material component or part of packaging 106 in assembly, while being in transit.

In an embodiment, the means 112 and the manipulator portion 204, along with their respective driving mechanisms may receive power from the manipulator transportation unit 104 via an inductive power supply cable following the track/path of the mover upon which the manipulation unit 110 is mounted.

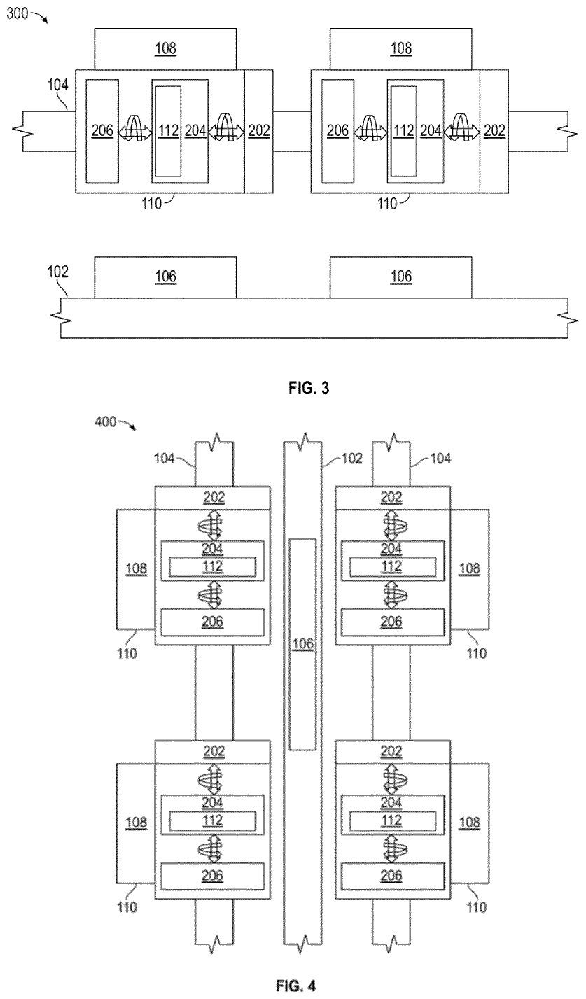

FIG. 3 illustrates the assembling and packaging system 100 that includes the manipulator transportation unit 104 with multiple manipulating units 110 operating, from the top, on multiple packaging 106 moving on the main transportation unit 102, at the bottom, in accordance with an embodiment of the present invention. The exemplary environment 300 shows a layout of the system 100 that includes one main transportation unit 102 carrying two packaging 106, such as cartons; and one manipulator transportation unit 104 with two manipulating units 110 operating on the packaging 106 from the top. In an embodiment, the main transportation unit 102 and the manipulator transportation unit 104 may be either parallel or non-parallel to each other. It should be noted that FIG. 3 is just an exemplary illustration, and the system 100 may include different other exemplary environment for performing the operations on the packaging 106 in different other ways, without deviating from the meaning and scope of the present invention.

The manipulating units 110 in the layout 300 may either operate together on an individual packaging 106, or may each individually operate on an individual packaging 106.

FIG. 4 illustrates the assembling and packaging system 100 in accordance with an embodiment of the present invention. The exemplary environment 400 shows a layout 400 including two manipulator transportation units 104 opposite to each other, where each manipulator transportation unit 104 has multiple manipulating units 110. Owing to the opposite configuration of the two manipulator transportation units 104, the manipulating units 110 are also opposite to each other. In between the two opposing manipulator transportation units 104 is a main transportation unit 102 transporting a packaging 106, in the present example of FIG. 4.

In the FIG. 4, the two opposing manipulator transportation units 104 may be positioned at the top and bottom of the main transportation unit 102, covering the top and bottom side on the packaging 106, in an embodiment. In another embodiment, the two opposing manipulator transportation units 104 may be positioned at the two opposing sides of the main transportation unit 102, covering the two opposing sides on the packaging 106.

In yet another embodiment, the two manipulator transportation units 104 may be parallel or non-parallel to each other. Thus, the two manipulator transportation units 104 may be positioned at the two adjacent sides of the main transportation unit 102, covering the two sides on the packaging 106.

In the present example of FIG. 4, the two opposing manipulating units 110 of the two opposing manipulator transportation units 104 operate, from the top and bottom, on multiple packaging 106 moving on the main transportation unit 102. It may also be the scenario of FIG. 4 that the two opposing manipulating units 110 of the two opposing manipulator transportation units 104 operate, from two opposing sides, on multiple packaging 106 moving on the main transportation unit 102.

The manipulating units 110 in the layout 400 may either operate together on an individual packaging 106 or may each individually operate on an individual packaging 106.

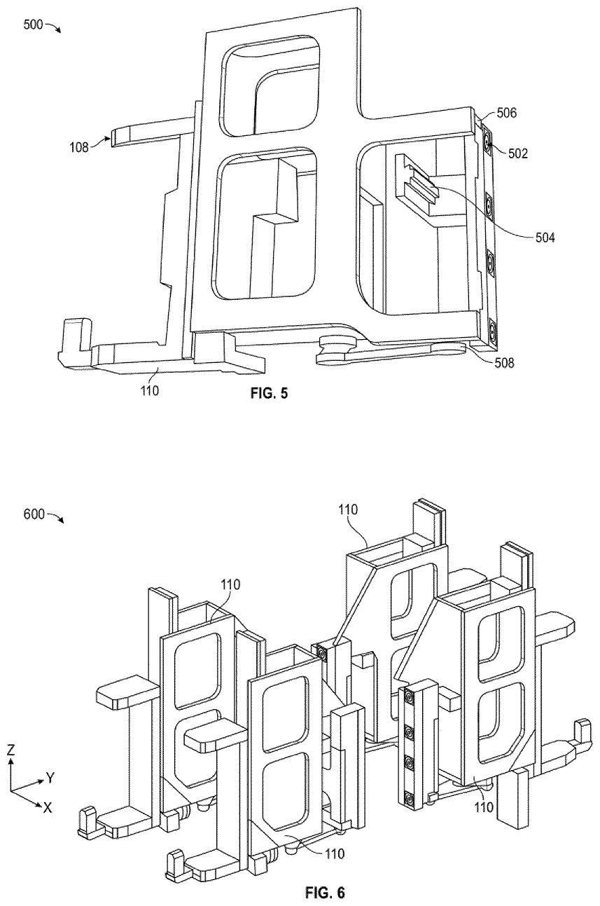

FIG. 5 illustrates an example of manipulating unit 110, in accordance with an embodiment of the present invention. The example 500 of the manipulating unit 110 may be an erecting and shaping manipulating unit 110 for erecting and shaping a packaging 106 in the system 100. The erecting and shaping manipulating unit 110 is attached to or the base portion integrated into the body of mover 108, and receives power from the mover 108 or via an inductive power supply cable following the track/path of the mover upon which the manipulation unit 110 is mounted.

The manipulating unit 110 further includes a wireless client device for wireless communication and wireless control of the manipulating unit 110 and its components or parts. The wireless client device may also be externally connected to the manipulating unit 110.

Further, the manipulating unit 110 (base and/or manipulating portions) may include one or more packaging temporary attachment and/or engagement means 112, such as including and not limited to suction cups 502, folding mechanism extension 504, and may also have a nestable packaging support face, such as toothed comb, and the like to bear on, guide, limit or otherwise control any bowing, flexing or distortion of the packaging material while formation occurs by the manipulation portion of the manipulation unit. Furthermore, a linkage mechanism such as a hinging mechanism 506 is included in the manipulating unit 110 for connecting and rotating the means 112.

Also, the manipulating unit 110 includes a driving mechanism such as a bell crank mechanism 508 for connecting and moving and/or rotating the whole manipulator portion 204, which includes the means 112, of the manipulating unit 110. The bell crank mechanism 508 is actuated by an actuation device, such as an actuation motor. This actuation device may receive power from the manipulator transportation unit 104 via the mover 108.

It may be apparent to a person skilled in the art that the manipulating unit 100 may have one or more any types of assembling and packaging means 112 for assembling and packaging a secondary package, with any type of linkage mechanism connecting and rotating the means 112 about the manipulating unit 110, and any type of driving mechanism that can drive the linkage mechanism, without being restricted to the ones shown in FIG. 5, without deviating from the meaning and scope of the present invention.

FIG. 6 illustrates a configuration of the system 100, similar to as shown in FIG. 4, including multiple manipulating units 110 operating on one packaging 106, in accordance with an embodiment of the present invention. The exemplary environment shows a layout 600 including two manipulator transportation units 104 opposite to each other, where each manipulator transportation unit 104 has multiple manipulating units 110. The manipulating units 110 may be the erecting and shaping manipulating units 110 in the example of FIG. 5.

Owing to the opposite configuration of the two manipulator transportation units 104, the erecting and shaping manipulating units 110 are also opposite to each other. In between the two opposing manipulator transportation units 104 would be a main transportation unit 102 transporting a packaging 106.

In the layout 600, the erecting and shaping manipulating units 110 may operate from two opposing sides of the packaging 106, such as for example top and bottom of the packaging 106, or two opposite right and left sides of the packaging 106.

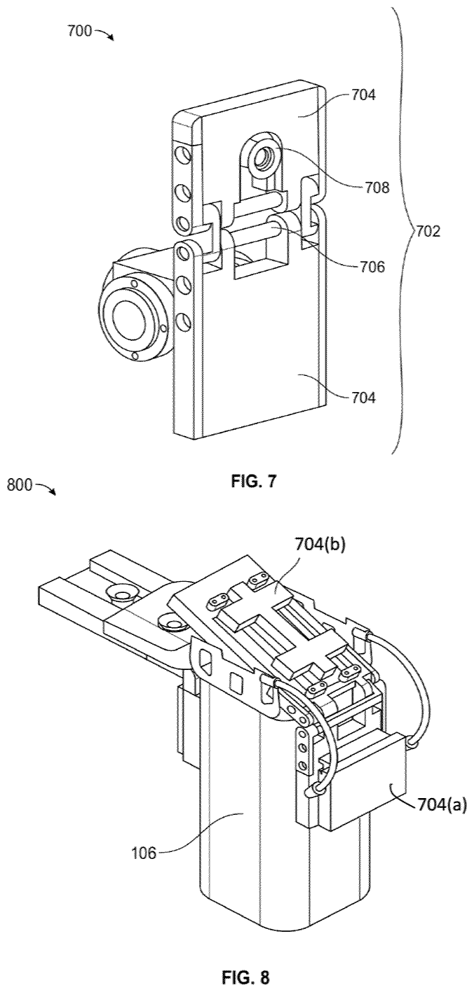

FIG. 7 illustrates a folding and closing means of an exemplary manipulating unit 110 for folding and closing a panel of a secondary package, as shown in in the FIG. 7, in accordance with an embodiment of the present invention. The example 700 shows a folding and closing means 702, of an exemplary folding and closing manipulating unit 110, includes hinged members 704 which are joined at a hinging mechanism 706, which in turn is driven by a driving mechanism. For gripping the secondary package 106 for performing assembling and packaging operations on the packaging 106, one or both of the hinged members 704 may have a gripping means 708. The gripping means may include and is not limited to a suction cup.

In an embodiment, such folding and closing manipulating unit 110 is attached to a mover 108, and receives power from the mover 108 or via an inductive power pick-up unit that is included in the manipulating unit 110 an inductive power supply cable following the track/path of the mover upon which the manipulation unit 110 is mounted.

The closing manipulating unit 110 includes a means 112 for closing for example a top panel of a carton. The means 112 may be a folding and closing means 702. The folding and closing means 702 may have two hinged members 704 joined with each other at a hinging mechanism 706. The two hinged members 706 can be rotated at an angle with respect to each other about the hinging mechanism 706. In an embodiment, the angle of rotation about the hinging mechanism 706 between the two hinged members 704 may vary from 0 degrees to 180 degrees. In another embodiment, the angle of rotation about the hinging mechanism 706 between the two hinged members 704 may vary from 0 degrees to 360 degrees.

Further, the closing manipulating unit 110 may include a driving mechanism that drives the hinging mechanism 706. The driving mechanism may comprise any type of actuation mechanism comprising any combination of and not being limited to direct drives (motors and/or actuators) and/or power transmission via, linkages, pivots, slides, gearing and/or rack & pinion transmissions, cable, pulley and/or cable & sheath arrangements, or lever and/or bell crank arrangements, being driven by motors or actuators directly or indirectly, on the manipulator unit or by varying the relative distances between two or more said independently motion controlled movers, connected by any actuation unit power transmission means. The two hinged members 704 may be attached to the driving mechanism, so the driving mechanism can move and rotate the hinged members 704 about the hinging mechanism 706.

The driving mechanism may receive power from an actuation motor included in the closing manipulating unit 110.

Thus, the actuation motor may drive the driving mechanism, depending on the requirement of closing the panel, which in turn rotates the hinged members 704 about the hinging mechanism 706. Therefore, any panel of the packaging 106 when gripped by any one or both of the hinged members 704 may be folded or closed or opened owing to the forces generated by the driving mechanism which travel to the hinged members 704 for moving and rotating them about their hinging mechanism 706.

FIG. 8 illustrates an exemplary environment implementing the example of manipulating unit 110, as shown in in the FIG. 7, for closing a secondary packaging 106 in the system 100, in accordance with an embodiment of the present invention. FIG. 8 illustrates a step 800 that shows two opposing closing manipulating units 110 operating on one secondary package 106 in between. The secondary package 106 can be held from the top by the main transportation units 102, in an embodiment. The folding and closing means 702 of one of the closing manipulating units 110 is folding and closing a top panel of the secondary package 106 in step 800. As can be seen in the FIG. 8, one of the hinged members 704(a)(b) has gripped a side of the secondary package 106 for a firm grip while closing and, the hinged member 704(b) has been rotated to an angle with respect to the gripping hinged member 704(a) about the hinging mechanism, by using the driving mechanism. Thus, closing the top panel of the secondary package 106. In an embodiment, after closing the panel, the hinged member 704(a) which was rotated and has closed the panel, retreats back to its original position. The original position may be aligning in upright position at 180 degrees with the gripping hinged member 704(b) or it may be aligned parallel on top of the gripping hinged member 704(b). The original position can be at any position and angle is not restricted to as explained here.

In an embodiment, the exemplary closing manipulating unit 110, as shown in in the FIG. 7 may have multiple hinged members 704 for performing the gripping, folding and closing operation on the packaging 106.

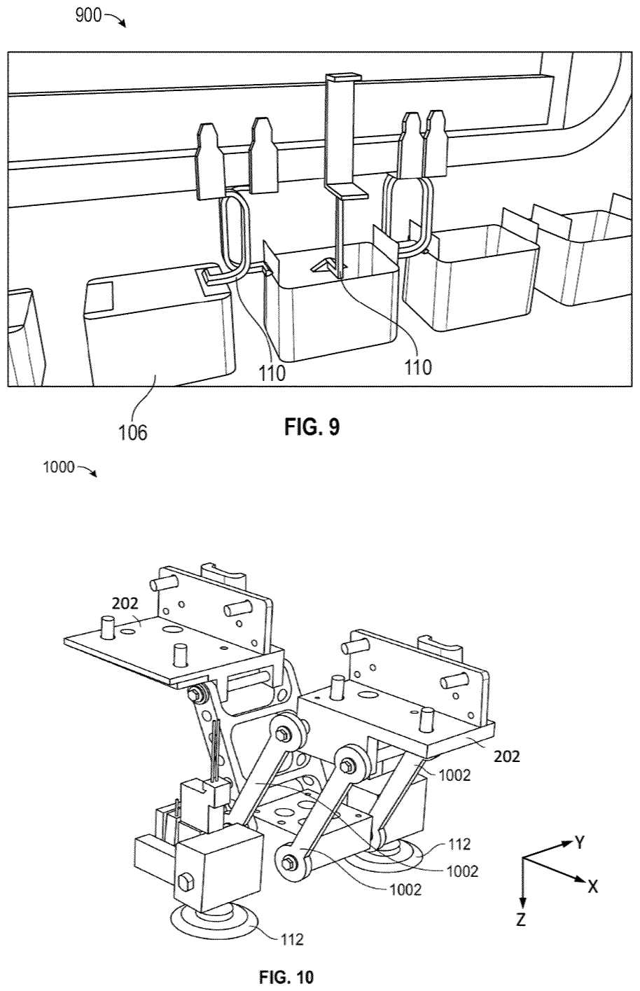

FIG. 9 illustrates an exemplary environment of the system 100 including one manipulator transportation unit 104 performing operations on one main transportation unit 102, in accordance with an embodiment of the present invention. In the exemplary environment 900, the system 100 works similarly as shown in the FIG. 3 above. The system 100 here in exemplary environment 900 has one manipulator transportation unit 104 with multiple manipulating units 110 that are operating, from the top, on multiple secondary packages 106 being transported on the main transportation unit 102 at the bottom. In the exemplary environment 900, the manipulating units 110 are folding and closing panels of the packaging 106.

The manipulating units 110 in the layout 900 may either operate together on an individual packaging 106, or may each individually operate on an individual packaging 106.

Further, in an embodiment of the system 100, as shown in FIGS. 5-9, the secondary package 106 can be transported, on the main transportation unit 102, in different orientations, angles, rotations, positions, and in multiple degrees of freedom, relative to both the main transportation unit 102 and the manipulating units 110 of the manipulator transportation unit 104. For example, the secondary package 106 can be transported in an upright position on the main transportation unit 102, or upside down position on the main transportation unit 102 or hung upside down position from the main transportation unit 102 which may be at top relative to the manipulator transportation unit 104.

It may be apparent to a person skilled in the art that the layouts in 300, 400, 600, 800 and 900 may include any type of manipulating units 110 for operating assembling and packaging operations on the packaging 106 from one or all sides and directions of the packaging 106, covering multiple dimensions, and multiple degrees of freedoms, without deviating from the meaning and scope of the present invention.

FIG. 10 illustrates another example of manipulating unit 110, in accordance with an embodiment of the present invention. The example 1000 of the manipulating unit 110 shows the means 112, such as suctions cups 112. The manipulating unit 110 with such means 112 is equipped with a pair of base portions 202 each to be installed on a motion controlled mover, where the pair of base portions is attached with each other, while being equipped on the manipulator transportation unit 104. The pair of base portions, and so the pair of movers, is connected with each other via a linkage mechanism 1002, such as a series hinged and rotatable linking rods, arms or members (linkages). These hinged and rotatable linking rods 1002 provide the driving and linking mechanism to the movers and eventually drive the means 112.

In the present example, the suction means 112 may be driven up and down along an axis by moving the connected pair of movers 108 closer and away from each other. Such movement of the movers 108 towards and away from each other is executed by utilizing the linkage mechanism 1002. Further, to grip a panel of a packaging 106 using such suction means 112, the suction means 112 may grip and hold the panel and can grip/handle/pick the panel, owing to its driving because of the series hinged and rotatable linking rods. The means 112 can grip/handle/pick the panel. Also, a small force can be applied by the means 112 with suction cups on the panel, using the linkage mechanism of series hinged and rotatable linking rods, to keep the panel in place.

It may be apparent to a person skilled in the art, that there may be one manipulating unit 110 which is mounted on a pair of connected movers 108, or mounted on more than two connected movers 108 which can be connected to each other via a linkage mechanism, in order to drive the one or more means 112 of the one manipulating unit 110, without deviating from the meaning and scope of the present invention. In FIG. 10 the linkage arrangement supporting and actuating the manipulation portion of the manipulation unit 110 is arranged that the manipulator portion is maintained parallel to the base portions 202 on the two movers, while the height (off-set) in the z-axis of the manipulator portion is varied by varying the relative pitch of the two base portions via variation of the pitch of the two movers upon which the base portions are mounted. In an alternative embodiment, of FIG. 10 with the mounting of the manipulation portion via appropriate linkages to three or more movers, not only the off-set along the z-axis perpendicular to the track of the movers may be executed, but also the angle of approach of the attachment means to the packaging material, as the mover set, upon which the manipulation unit is mounted, travels along the tracks of the manipulation transportation unit. It may also be apparent to a person skilled in the art, that there may be one or more manipulating units 110 which are mounted on a pair of connected movers 108, or mounted on more than two connected movers 108 which can be connected to each other via a linkage mechanism, in order to drive the one or more means 112 of the one or more manipulating unit 110, without deviating from the meaning and scope of the present invention.

Advantageously, the present system 100 includes manipulating units 110 with means 112 which smartly operated and controlled, and are actuated independently of the dynamic precision of the mover 108. Also, the manipulating units 110 with means 112 can be actuated without application of external (actuation) loads on the mover 108. The manipulating units 110 with means 112 can also provide automation feedback sensing (status, limits reached, malfunctions, condition monitoring)

Additionally, the manipulating units 110 with means 112 can perform a variety of actions (not just one actuation) and optionally perform them simultaneously. They can also benefit from availability of Hydraulics, via a mini Mover 108 mounted hydraulic pump (eg. Hydraulic Actuators). Furthermore, they can also benefit from availability of Pneumatics, via a mini Mover 108 mounted compressor (eg. Pneumatic Pistons), while also can benefit from availability of Vacuum, via a mini Mover 108 mounted Vacuum Pump (eg. Suction Cups).

Further, the manipulating units 110 with means 112 can benefit from availability of Electricity, powering, such as including and utilizing components such as Motors (Stepper, Servo, AC/DC); Linear Actuators; Solenoids; Electrically Powered Devices for eg. Heating, Cooling, Ultra-Sonics, Lasers; On-Board Local Control System (Local Logic); Feedback Sensors (DIO, AIO) for Vibration, Pressure, Temperature, Position, Distance etc.; and Feedback for Status and Condition monitoring.

The manipulating units 110 with means 112 can also have on-board micro-processing (instructed and reporting to the central control system 114), and can be dynamically flexible, adjustable, optimizable (respond to AI/Machine Learning optimizations)

Additionally, manipulating units 110 with means 112 can also have response times independent of Linear Drive Motor Powers, Mover & Tooling+Payload Weights

The system 100 with the manipulating units 110 with means 112 can operate independently of Mover-Mover proximity, and the movers can be flexibly synchronized with actions of other movers.

The manipulating units 110 with means 112 of the system 100 can be operation specific, pack for pack, motion profile adjusted/actuation optimized. Further, they can activate and control a variety of different material handling/attaching devices, such as eg. Clamping Grippers, Suction Grippers, Needle Grippers, Gecko (Van Der Waals Force), Electro-Magnetic Adhesion.

The manipulating units 110 with means 112 are also self-adjusting and highly adaptable. They can also be adjusted via a programmable change station/positioned at one or more locations about the track of the Linear Drive. Furthermore, they can also be flexibly, variable speed motion controlled and synchronized with other on-board actions as well as those on other tools.

Also, the manipulating units 110 with means 112 can be mounted on one or more movers 108 (for eg. additional weight carrying capability) and can be used in combination with Mover-Mover actuated articulations.

The manipulating units 110 with means 112 can also be used in combination with an external Cam (if that we the best solution for eg. power/stroke reasons). Also, they can be configured for manual, semi-automated or automated Custom Tooling exchange which can include tool-less changeover, auto-ID (via eg. RFID) and integrated with location and secure retention tooling mounting on the Mover and connection with Mover on-board services such as Power, Control, Pneumatics, Hydraulics, Vacuum.

1. A system for processing a packaging in assembly comprising a main transportation unit; and
a manipulator transportation unit having at least one manipulating unit, said manipulating unit mounted on at least one independently motion controlled mover and adapted for manipulating a material component of a package in assembly present at the main transportation unit, wherein said manipulating unit comprises an engagement device for temporarily engaging a material component of a package in assembly while being in transit.

2. The system of claim 1, wherein the engagement device is for temporarily attaching to and releasing from the material component of the package in assembly while being in transit.

3. The system according to claim 1, wherein the said manipulation unit is adapted to pick, fold, form, shape, wrap, bend, stretch, push, press, force, off-set, compress, tuck, pull, rotate, cut, crease, score, collapse, insert, align, or latch or any combination thereof, the material component of the package in assembly.

4. The system according to claim 1, comprising a manipulation driving mechanism for driving said manipulating unit, said manipulation driving mechanism comprising any type of linkage mechanism, pivots, slides, or bell cranks, being driven by motors or actuators on the manipulating unit or by varying the relative distances between at least two of said independently motion controlled movers.

5. The system according to claim 4, wherein the manipulating unit comprises
a base portion,
a manipulator portion attached to the base portion and rotatable about the base portion, wherein the manipulation driving mechanism comprises a rotation driving mechanism for driving the rotation of the manipulator portion, and wherein the engagement device is located on the manipulator portion and/or the base portion.

6. The system according to claim 1, wherein the manipulator transportation unit transports one or more pairs of said manipulating units manipulating said material component from opposed or from various directions.

7. The system according to claim 1, wherein the manipulating units are wirelessly controlled and/or wireless powered and/or position sensed.

8. The system according to claim 1, comprising an assembly of at least two manipulator transportation units for manipulating from each side of the package in assembly on the main transportation unit.

9. The system according to claim 1, comprising a control system enabling synchronization of the pace and pitch of the manipulation units with the transportation of the package in assembly on the main transportation unit.

10. The system according to claim 1, wherein the main transportation unit comprises individually motion controlled movers and tools on the individually motion controlled movers; wherein the tools on the individually motion controlled movers of the main transportation unit are configured to provide packaging process operations to said given packaging in assembly, and wherein the control unit enables the control of the manipulating units and said tools for simultaneously manipulating a material component of said given packaging in assembly.

11. The system according to claim 1, comprising a plurality of the manipulator transportation units and wherein the control system further enables the control of the manipulating units for simultaneously manipulating a material component of said given packaging in assembly.

12. The system according to claim 1, further comprising a change-over station for loading and/or receiving and storing inactive manipulation units and/or for adaptation and/or adjustment of manipulation units.

13. A method for assembling a package comprising the steps of providing a given package in assembly onto a main transportation unit, and manipulating a material component of the given package in assembly using a system of claim 1.

14. The method for assembling a package in accordance with claim 13 wherein manipulating comprises,
i) moving one or more material components or part thereof into a given direction,
ii) rotating the package in assembly or the final assembled package,
iii) accelerating, decelerating, attaching, inserting, pressing, holding, wrapping, folding, tucking, off-setting, translating, rotating, pushing, pressing, inclining, stretching, compressing, collapsing, erecting, gluing, latching a material component of a package in assembly, and all combinations thereof.

15. The method according to claim 13, wherein the material component to be manipulated is a part of a foldable blank based package.
